(19) United States
(12) Patent Application Publication
(10) Pub. No.: US 2012/0136960 A1
(43) Pub. Date: May 31, 2012

(54) Cloud Storage Data Access Method, Apparatus and System

(75) Inventor: Hui Liu, Beijing (CN)

(73) Assignee: Beijing Z & W Technology Consulting Co., Ltd, Haidian District, Beijing (CN)

(21) Appl. No.: 13/000,569

(22) PCT Filed: Dec. 1, 2010
(86) PCT No.: PCT/CN2010/079310

§ 371 Date: Dec. 21, 2010

(30) Foreign Application Priority Data
Nov. 29, 2010 (CN) 201010564240.6

(51) Int. Cl. G06F 15/16

(52) U.S. Cl. 709/217

(57) ABSTRACT

This invention relates to technology field of cloud storage and especially relates to a cloud storage data access method. The method comprises: a step of data storing and a step of data retrieving. The data storing step comprises: converting a file to be stored into a group of data blocks to form a physical part of the file, saving a logical part of the file, which is formed by information of restoring the physical part back to original file; distributing the physical part to multiple cloud storage data centers for storage; and saving storing location information of the data blocks of the physical part in the cloud storage data centers in the logical part; the step of data retrieving comprises: acquiring the file's logical part according to a file access request; retrieving the physical part of the file from at least one of the cloud storage data centers according to the logical part information and restoring the physical part to the original file according to the logical part information. This invention also provides a cloud storage data access apparatus and system. This invention improves cloud storage data access performance, facilitates storage space saving, increases data transmission bandwidth, and strengthens data security.

### TECHNICAL FIELD

This invention relates to the cloud storage technology field and especially relates to a cloud storage data access method, apparatus and system.

### BACKGROUND OF THIS INVENTION

Data has proven to be an important asset of enterprises, and the rapid growth of data has made enterprises facing unprecedented challenges. Meanwhile, the cost pressure brought by the rapidly changing world economic situation and fierce competition enables enterprises to have to consider how to reduce IT costs and meet the growing storage needs of enterprises.

The existing storage architecture can be classified into two types: one is a proprietary architecture for one party, such as the DAS (Direct Attached Storage), SAN (Storage Area Network, Storage Area Network) and NAS (Network Access Server). Such storage systems are exclusively used by one party and can provide users with very good control, better reliability and performance, but due to their poor scalability, they do not apply to large-scale deployment; it is quite difficult for users in this mode to flexibly use storage budgets, and a one-time investment is needed to buy storage equipment; along with the increase in storage capacity, the cost control will also face challenges.

The other is a multi-party sharing architecture, that is, cloud storage architecture. According to their different service scopes, they are classified into private cloud and public cloud. The architecture of cloud storage based on network technologies (internet and intranet) provides users with on-demand purchasing and leasing of storage space, and on-demand configuration service; namely, usually, a third party or third-party department in enterprises provides storage apparatus and specialized maintenance personnel. Through the storage service, enterprises or various departments within the enterprises can significantly reduce their internal storage requirements and corresponding administrative costs, to balance the sharply rising storage requirements and business cost pressure. The users who adopt the storage service can be individuals, enterprises, or even departments within the enterprises or branch offices.

Regardless of public cloud or private cloud, data transmission mainly happens over the internet or enterprise intranet. Limited network bandwidth and all kinds of chaos in real environment may influence the speed of data backup and archive into the cloud storage data center and data retrieval back from the data center, and further influence storage space and data availability and customers' satisfaction.

The existing cloud storage service methods of processing file for storage before transmission (in fact, all data to be stored can be converted into file with some methods) and then transmitting the processed file to a cloud storage center can be classified into two categories:

The first category is optionally splitting a file into smaller parts, and then storing the non-split file or split parts into one cloud storage data center. The characteristic of this method is to store data into one cloud storage data center. During file splitting, all the parts are further compared and the duplicate ones are deleted to save data transmission network bandwidth and storage space on server side. Typical embodiments comprise IBM and CommVault cloud storage solutions. The data storing and retrieving speed of this method will be limited by assignable network bandwidth of the cloud storage data center, because the input/output network bandwidth of the cloud storage data center is always limited and usually shared by many connections. Therefore, the bandwidth assigned to a certain connection is often not ideal.

The second category is splitting a file into smaller parts and then storing each part separately into one corresponding data center. This method has been published in China Patent Application No. CN 200910143245.9 “A Method to Enable the Cloud Storage Parallel System.” The characteristic of this type of method is to split file into multiple parts and save them one by one to corresponding data centers. Through multi-process parallel data transmission and retrieval, the network bandwidth of different data centers is fully utilized, and the negative impact of limited network bandwidth on performance is reduced. But this type of method has restricted each data part to only one corresponding data center (data centers here could be cloud storage data centers belonging to one or more cloud service providers), therefore there are some limitations:

1. Because building a cloud storage data center requires a huge investment, there are often limited cloud storage data centers available in the market. As each data part and data storage center is one-to-one correspondent, it will result in bigger granularity of data part, especially for large file split and store. However too big granularity of data parts, will cause the difficulty to effectively de-duplicate them before transferred to determined cloud storage data server (data deduplication can reduce data size to transfer) to save network bandwidth and storage space;

2, In addition, storing too big partial files with continuous contents in one data center will not benefit data security and privacy protection. A typical case is the data center administrators, especially of super administrator who has no limitation in accessing all stored data and whose any operation mistake and problem in professional ethics will result in the risk of data leak and further cause inestimable loss to enterprise. Although this disclosure has adopted data encryption method to protect data security from unauthorized usage, as the decryption hardware price declines and performance improves dramatically, the security of data encryption being challenged.

Therefore, it is necessary to create a new cloud storage data access method, which allows users to save multiple parts of a file in multiple cloud storage data centers, and especially allows multiple parts of one file can be saved in one cloud storage data center.

### SUMMARY OF THIS INVENTION

The purpose of this invention is to provide a cloud storage data access method, apparatus and system to address the problems in existing cloud storage method, such as the bottlenecked performance of data storing and retrieving due to assignable network bandwidth of a cloud storage data center end; and data security and privacy protection problem caused by split data one-to-one corresponding to cloud storage data center.

This invention provides a cloud storage data access method comprising a step of data storing and a step of data retrieving:

the data storing step comprises:

converting a file to be stored into a group of data blocks to form a physical part of the file and saving a logical part of the file, which is formed by information of restoring the physical part back to the original file;

distributing the physical part to multiple cloud storage data centers for storage; and

saving storing location information of the data blocks of the physical part in the cloud storage data centers, in the logical part;

the data retrieving step comprises:

acquiring the file's logical part according to a file access request;

retrieving the physical part of the file from at least one of the cloud storage data centers according to the logical part; and

restoring the physical part back to the file according to the logical part.

This application provides a cloud storage data access apparatus comprising a data storage module for storing data and a data retrieval module for retrieving data.

the data storage module comprises:

a file conversion unit used for converting a file to be stored into a group of data blocks and forming a physical part of the file;

a physical part transmission unit used for distributing the physical part formed by the file conversion unit to multiple cloud storage data centers for storage; and

a logical part storage unit used for saving information of restoring the physical part back to the original file, when the file conversion unit converts the file and forms the physical part, and saving storing location information of the data blocks of the physical part in the cloud storage data centers, after the physical part transmission unit transmits the physical part;

the data retrieval module comprises:

a logical part acquisition unit used for acquiring the logical part of the file according to a file access request;

a physical part retrieval unit used for retrieving the physical part of the file from at least one of the cloud storage data centers according to the logical part acquired by the logical part acquisition unit; and

a file recovery unit used for restoring the physical part retrieved by the physical part retrieval unit to the original file according to the logical part acquired by the logical part acquisition unit.

This invention also provides a cloud storage data access system comprising a data storage module for storing data and a data retrieval module for retrieving data, and multiple cloud storage data centers.

the data storage module comprises:

a file conversion unit used for converting a file to be stored into a group of data blocks to form a physical part of the file;

a physical part transmission unit used for distributing the physical part to multiple cloud storage data centers for storage; and

a logical part storage unit used for saving information of restoring the physical part back to the original file, when the file conversion unit converts the file and forms the physical part, and saving storing location information of the data blocks of the physical part in the cloud storage data centers, after the physical part transmission unit transmits the physical part;

the data retrieval module comprises:

a logical part acquisition unit used for acquiring the logical part of the file according to a file access request;

a physical part retrieval unit used for retrieving the physical part of the file from at least one of the cloud storage data centers according to the logical part acquired by the logical part acquisition part; and

a file recovery unit used for restoring the physical part retrieved by the physical part retrieval unit back to the original file according to the logical part acquired by the logical part acquisition unit.

By converting, distributing and saving the file to be stored into multiple cloud storage data centers, this invention will improve the cloud storage data access performance, facilitate storage space saving, increase data transmission bandwidth, and strengthen data security.

### BRIEF DESCRIPTION OF THE DRAWINGS

FIG. 1 is a flow chart of a cloud storage data access method in accordance with an embodiment of this invention;

FIG. 2 is a structural diagram of a cloud storage data access apparatus in accordance with an embodiment of this invention;

FIG. 3 is a structural diagram of a physical part transmission unit in accordance with an embodiment of this invention;

FIG. 4 is a structural diagram of a cloud storage data access system in accordance with an embodiment of this invention.

### DETAILED DESCRIPTION OF THE PRESENTLY PREFERRED EMBODIMENTS

The following embodiments and drawings are provided for further illustrating but not for limiting the present invention.

In accordance with an embodiment of this invention, a cloud storage data access method comprises these steps: converting a file to be stored into a group of data blocks to form a physical part of the file, saving a logical part of the file, which is formed by information of restoring the physical part back to the original file, transmitting the physical part to multiple cloud storage data centers for storage and meanwhile saving storing location information of the data blocks of the physical part in the cloud storage data centers in the logical part; when the file requires to be retrieved, acquiring the logical part of the file, and then according to the logical part, retrieving the physical part of the file from at least one of the cloud storage data centers and further restoring it back to the original file.

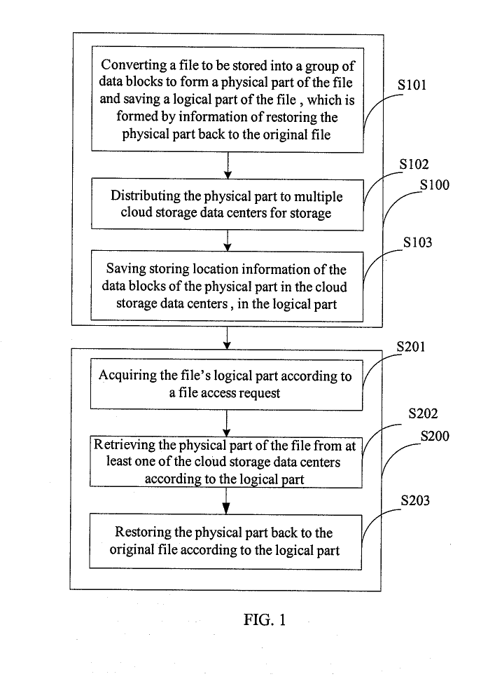

As shown in FIG. 1, in accordance with an embodiment of the invention, a cloud storage data access method comprises data storing step S100 and data retrieving step S200;

The data storing step S100 comprises:

Step S101: converting a file to be stored into a group of data blocks to form a physical part of the file and saving a logical part of the file, which is formed by information of restoring the physical part back to the original file;

There are many kinds of file conversion methods can be applied to the embodiment of this invention, including splitting file by fixed or variable size that can be predetermined or randomly generated. In the embodiment of this invention, a file splitting by fixed size (such as 512 KB) method is adopted to convert the file to be stored into corresponding physical part data blocks and then form the corresponding logical part of the file.

The logical part of the file comprises information, such as composition of the data blocks of physical part of a file, the storing location of data blocks, and rules to recompose data blocks back to the original file, etc.; in addition, according to the needs in practice, the logical part of file may also comprise file attributes, access authority and check values (such as MD5 value, to verify the accuracy of the contents of the retrieved file), and other information.

Information of the logical part of a file may be stored in users' local server, or in a storage server that is not being used to store the file, such as an intermediate storage proxy server.

Step S102: distributing the physical part to multiple cloud storage data centers for storage;

The step of transmitting the physical part to multiple cloud storage data centers comprises: according to user's predefined policy, binding data blocks of the physical part dispersedly and randomly to multiple predetermined cloud storage data centers; according to the binding setting between data blocks of physical part and the cloud storage data centers, distributing the physical part to the multiple predetermined cloud storage data centers for storage by multi-process parallel transmission.

In practical application, there are many methods to bind data blocks of the physical part dispersedly and randomly to multiple predetermined cloud storage data centers, such as, placing data blocks at odd position on cloud storage center 1 and data blocks at even position on cloud storage center 2; or according to total number of available cloud storage centers, randomly distributing the physical part data blocks of all files on the cloud storage data centers; or before transmitting the physical parts to multiple cloud storage centers, generating a distributed placement rule based on user's needs and then, according to this rule, distributing the physical part to multiple cloud data centers for distributed storage.

This embodiment does not limit the number of cloud storage data centers for use to store data; at the same time, each cloud storage data center is not limited to store only one data block of a file's physical part, that is, each cloud storage data center may store one or multiple data blocks of a file's physical part; in addition, a file's physical part composed of data blocks can be placed on multiple cloud storage data centers.

Step S103: saving storing location information of the data blocks of the physical part in the cloud storage data centers, in the logical part;

In practice, when customers select a file to store in the cloud storage data center, the file can be converted into a group of data blocks with a specified size, namely a physical part of the file, in accordance with preset backup strategy and schedule, meanwhile the logical part formed by information of restoring physical part back to original file is saved, and then the physical part data blocks are transmitted to multiple determined cloud storage data centers for storage by multi-process parallel transmission according to the generated data dispersedly-randomly storing policy and preset cloud storage service access agreement, such as authorization, payment bill records, etc., and the storing location information of each data block of the physical part in the cloud storage centers is saved into the logical part.

Data retrieving step S200 comprises these sub steps:

Step S201: acquiring the file's logical part according to a file access request;

Step S202: retrieving the physical part of the file from at least one of the cloud storage data centers according to the logical part; and

Step S203: restoring the physical part back to the original file according to the logical part.

When external file access request is received, the logical part of the file is firstly acquired, and then according to it, the data blocks of physical part of the file and the storing location of the data blocks in the cloud storage center are ascertained, then according to a preset cloud storage service access agreement, such as certification, payment bill records, etc., the physical part of the file is retrieved from at least of the cloud storage data centers and restored back to the original file according to the logical part.

In practice, as the size of the data blocks of the physical part can be set at the time of file conversion, the size of each data block divided can be small enough, and if the policy/algorithm of the data blocks dispersedly-randomly storing is ideal, then the different parts of a file stored in each cloud storage data center may be discontinuous and very difficult to be restored into continuous information of the original file or even partial file. Moreover, a cloud storage data center may comprise several parts of a file, but as each split and converted part is small enough and the content of all parts is not continuous, it reduces the risk of data leakage caused by any operation mistake and problem in professional ethics of the data center administrators and especially of the super administrators who have no limitation in accessing all the data stored in data center and thus strengthens users' data security and privacy protection.

For application of this embodiment in practice, during transmitting the physical part to multiple cloud storage data centers and retrieving the physical part back from the cloud storage data centers according to a logical part, network bandwidth of multiple data centers may be fully utilized and multi-process parallel transmission is adopted, so that the data access performance of cloud storage service may be greatly improved.

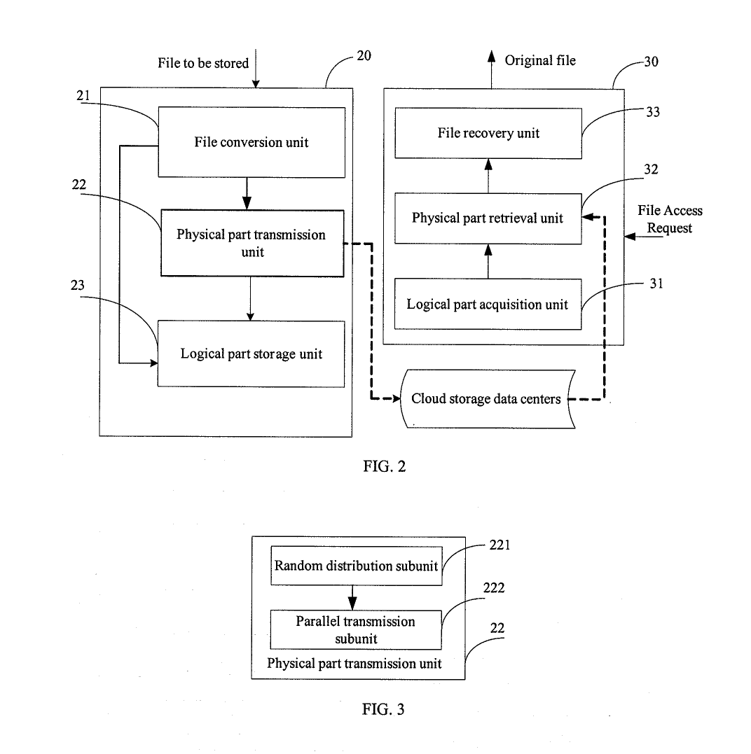

As shown in FIG. 2, the embodiment of this invention provides a cloud storage data access apparatus comprising data storage module 20 used for storing data and data retrieval module 30 used for retrieving data.

The data storage module 20 comprises:

File conversion unit 21 used for converting a file to be stored into a group of data blocks and forming a physical part of the file;

Physical part transmission unit 22 used for transmitting the physical part of the file converted by the file conversion unit to multiple cloud storage data centers for storage; and

Logical part storage unit 23 used for saving the information of restoring the physical part back to the original file, when the file conversion unit 21 converts the file to form the physical part, and saving storing location information of the data blocks of the physical part in the cloud storage data centers, after the physical part transmission unit 22 transmits the physical part.

When storing the file, the file conversion unit 21 may, according to the preset backup policy and schedule, convert the stored file into a group of data blocks to form the physical part of file; the physical part transmission unit 22 transmits the physical part formed by the file conversion unit 21 to multiple cloud storage data centers for storage; while the file conversion unit 21 converts the file to form physical part; the logical part storage unit 23 saves the information of restoring the physical part back to the original file and the storing location information of all the data blocks of the physical part in the cloud storage centers after the physical part transmission unit 22 transmits the physical part formed by file conversion unit 21 to multiple cloud storage data centers.

As shown in FIG. 3, the physical part transmission unit 22 comprises:

Random distribution subunit 221 used for binding data blocks of physical part converted by file conversion unit 21, dispersedly and randomly to multiple predetermined cloud storage data centers according to user's predefined policy;

Parallel transmission subunit 222 used for distributing the physical part to multiple determined cloud storage data centers for storage by multi-process parallel transmission according to the binding setting between data blocks of physical part and cloud storage data centers, created by the random distribution subunit 221.

The data retrieval module 30 comprises:

Logical part acquisition unit 31 used for acquiring the logical part of a file according to a file access request;

Physical part retrieval unit 32 used for retrieving the physical part of the file from at least one of the cloud storage data centers according to the logical part acquired by logical part acquisition unit 31;

File recovery unit 33 used for restoring the physical part retrieved by the physical part retrieval unit 32 into original file according to the logical part acquired by logical part acquisition unit 31.

When it is necessary to retrieve the stored file, based on file access request, the logical part acquisition unit 31 acquires the logical part of the accessed file, ascertains the physical part of file and data blocks storing location information in the cloud storage data center, the physical part retrieval unit 32 retrieves the physical part of file according to the logical part of the file acquired by logical part acquisition unit 31, file recovery unit 33 restores the file physical part retrieved by physical part retrieval unit 32 into the original file according to the logical information of the file acquired by logical part acquisition unit 31.

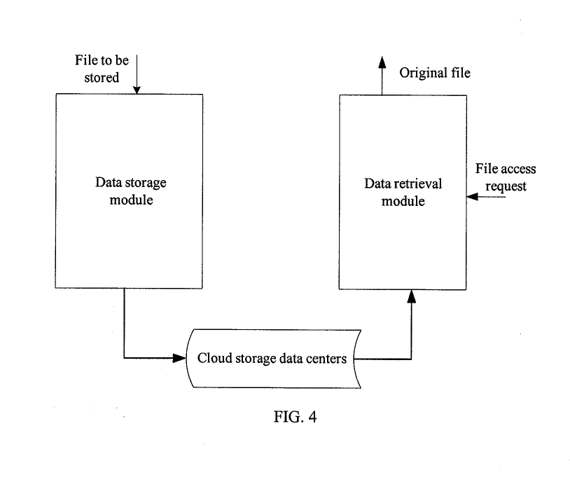

As shown in FIG. 4, this invention also provides a cloud storage data access system, which comprises a data storage module for storing data, a data retrieval module for retrieving data, and multiple cloud storage data centers.

The data storage module comprises:

a file conversion unit used for converting a file to be stored into a group of data blocks to form the physical part of the file;

a physical part transmission unit used for distributing the physical part formed by the file conversion unit to multiple cloud storage data centers for storage; and

a logical part storage unit used for saving information of restoring the physical part back to the original file, when the file conversion unit converts the file and forms the physical part, and saving storing location information of the data blocks of the physical part in the cloud storage data centers, after the physical part transmission unit transmits the physical part;

The data retrieval module comprises:

a logical part acquisition unit used for acquiring the logical part of the file according to file access request;

a physical part retrieval unit used for retrieving the physical part of the file from at least one of the cloud storage data centers according to the logical part acquired by the logical part acquisition part; and

a file recovery unit used for restoring the physical part retrieved by the physical part retrieval unit back to the original file according to the logical part acquired by the logical part acquisition unit.

Further, the physical part transmission unit comprises:

a random distribution subunit used for binding data blocks of physical part, converted by file conversion unit from file, dispersedly and randomly to multiple predetermined cloud storage data centers according to user's predefined policy; and

a parallel transmission subunit used for distributing the physical part to multiple determined cloud storage data centers for storage by multi-process parallel transmission according to the binding setting between data blocks of physical part and cloud storage data centers, created by the random distribution subunit.

Further, the cloud storage data centers can store one or multiple data blocks of the physical part of a file.

In an embodiment of this invention, a file may be stored dispersedly without the restriction in the number of the storage servers to use, and each storage server is not limited to save only one part of file, that is, multiple split and converted parts of a file are allowed to be stored in multiple cloud storage data centers, and a cloud storage data center is also allowed to save multiple parts of a file, which is different from method published in the document CN 200910143245.9, A Method to Enable the Cloud Storage Parallel System, in accordance with which only one part of a file is allowed to be stored on one cloud storage data center.

By converting a file to be stored into data blocks of physical part and dispersedly storing them on different cloud storage data centers, thus fully utilizing network bandwidth provided by multiple data centers to transmit and retrieve back the file content with multi-process parallel transmission method, this invention improves the data access performance of cloud storage service; meanwhile, by splitting and converting file into smaller parts, this invention facilitates the data deduplication within a file or across files, which saves storage space and cloud storage data transmission bandwidth; by storing data according to preset data dispersedly-randomly storing policy, this invention can reduce data leak risk caused by operation mistake and problems professional ethics of data center administrators.

Preferred embodiments are provided above to illustrate, but not to limit, the present invention; any changes, equivalent replacement and improvements and other aspects made within the spirit and principle of this invention should be covered in the protective range of this invention.

1. A cloud storage data access method comprising a step of data storing and a step of data retrieving wherein:
the data storing step comprises:
converting a file to be stored into a group of data blocks to form a physical part of the file and saving a logical part of the file, which is formed by information of restoring the physical part back to the original file;
distributing the physical part to multiple cloud storage data centers for storage; and
saving storing location information of the data blocks of the physical part in the cloud storage data centers, in the logical part;
the data retrieving step comprises:
acquiring the file's logical part according to a file access request;
retrieving the physical part of the file from at least one of the cloud storage data centers according to the logical part; and
restoring the physical part back to the file according to the logical part.

2. The method of claim 1 wherein the step of distributing comprises;
binding the data blocks of the physical part dispersedly and randomly to multiple predetermined cloud storage data centers based on users' predetermined rule; and
distributing the physical part to multiple determined cloud storage data centers for storage by multi-process parallel transmission based on the binding setting between the data blocks of the physical part and the cloud storage data centers.

3. The method of claim 1 wherein the logical part is stored at a local server or a server that is not being used to store the physical part.

4. The method of claim 1 wherein each of the cloud storage data centers stores one or more data blocks of the physical part of the file.

5. The method of claim 1 wherein the logical part comprises information about composition of the data blocks of the physical part, storing location of the physical part in the cloud storage data centers, approach to recompose data blocks, and the attribute, access authority and check value information of the file.

6. A cloud storage data access apparatus comprising a data storage module for storing data and a data retrieval module for retrieving data; wherein:
the data storage module comprises:
a file conversion unit used for converting a file to be stored into a group of data blocks and forming a physical part of the file;
a physical part transmission unit used for distributing the physical part formed by the file conversion unit to multiple cloud storage data centers for storage; and
a logical part storage unit used for saving information of restoring the physical part back to the original file, when the file conversion unit converts the file and forms the physical part, and saving storing location information of the data blocks of the physical part in the cloud storage data centers, after the physical part transmission unit transmits the physical part;
the data retrieval module comprises:
a logical part acquisition unit used for acquiring the logical part of the file according to a file access request;
a physical part retrieval unit used for retrieving the physical part of the file from at least one of the cloud storage data centers according to the logical part acquired by the logical part acquisition unit; and
a file recovery unit used for restoring the physical part retrieved by the physical part retrieval unit to the original file according to the logical part acquired by the logical part acquisition unit.

7. The apparatus of claim 6 wherein the logical part transmission unit comprises:
a random distribution subunit used for binding the data blocks of the physical part, dispersedly and randomly to multiple predetermined cloud storage data centers according to a user's predefined policy; and
a parallel transmission subunit used for distributing the physical part to multiple determined cloud storage data centers for storage by multi-process parallel transmission according to the binding setting between the data blocks and the cloud storage data centers created by the random distribution subunit.

8. A cloud storage data access system comprising a data storage module for storing data, a data retrieval module for retrieving data, and multiple cloud storage data centers, wherein:
the data storage module comprises:
a file conversion unit used for converting a file to be stored into a group of data blocks to form a physical part of the file;
a physical part transmission unit used for distributing the physical part to multiple cloud storage data centers for storage; and
a logical part storage unit used for saving, information of restoring the physical part back to original file, when the file conversion unit converts the file and forms the physical part, and saving storing location information of the data blocks of the physical part in the cloud storage data centers, after the physical part transmission unit transmits the physical part;
the data retrieval module comprises:
a logical part acquisition unit used for acquiring the logical part of the file according to a file access request;
a physical part retrieval unit used for retrieving the physical part of the file from at least one of the cloud storage data centers according to the logical part acquired by the logical part acquisition part; and
a file recovery unit used for restoring the physical part retrieved by the physical part retrieval unit back to the original file according to the logical part acquired by the logical part acquisition unit.

9. The system of claim 8 wherein the physical part transmission unit comprises:
a random distribution subunit used for binding the data blocks of the physical part dispersedly and randomly to multiple predetermined cloud storage data centers according to a user's predefined policy; and
a parallel transmission subunit used for distributing the physical part to multiple determined cloud storage data centers for storage by multi-process parallel transmission according to the binding setting between the data blocks of physical part and the cloud storage data centers created by the random distribution subunit.

10. The system of claim 8 wherein each of the cloud storage data centers stores one or more data blocks of the physical part of the file.
